(19) United States
(12) Patent Application Publication
(10) Pub. No.: US 2007/0236568 A1
(43) Pub. Date: Oct. 11, 2007

(54) Method and system for communicating incident scene information

(76) Inventors: Anthony R. Metke, Naperville, IL (US); George Popovich, Palatine, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/402,246

(22) Filed: Apr. 11, 2006

(51) Int. Cl. H04N 7/18

(52) U.S. Cl. 348/143

(57) ABSTRACT

A method and system for communicating incident scene information between wireless devices in an ad hoc network is useful for providing an updated source of incident scene information. The method comprises providing an Incident Scene Services Database (ISSD) in a first wireless device (step 305). An update of the ISSD comprising a service advertisement from a second wireless device is then received at the first wireless device (step 315). An indication is then provided at the first wireless device of availability of a service described in the service advertisement received from the second wireless device (step 320).

### FIELD OF THE INVENTION

The present invention relates generally to ad hoc communication networks, and in particular to a method and system for communicating incident scene information between wireless devices in an ad hoc communication network.

### BACKGROUND

Incident scene response teams such as firefighters and law enforcement officials are often faced with communication confusion and a lack of accurate information when they first arrive at an incident scene. Tactical errors, injuries and even deaths are sometimes attributed to poor initial communication between members of an incident scene response team.

For example, police officers arriving at the scene of a suspected crime in progress can inadvertently injure innocent bystanders or other police officers if the arriving officers are not readily provided with detailed descriptions of suspects and other individuals who are already at the scene. Further, firefighters can be forced to make high-risk decisions concerning entering a burning building if they are not provided with instant communications concerning all known information about the nature of a fire and whether people remain trapped in the building.

Recently ad hoc wireless networks are being implemented to provide useful communications between incident scene response team members. Various types of ad hoc wireless network protocols, devices and related technologies have been developed for use at critical incidents. Police and firefighters for example can carry personal radio devices that are networked with various other radio devices and sensors. It will be appreciated that instant wireless communications between members of an incident scene response team can enable the team to act more effectively.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating the functional components of a wireless device that is a node of an ad hoc wireless network and that is adapted to perform functions of the present invention, according to an embodiment of the present invention.

FIG. 2 is a diagram illustrating elements of an incident scene launch page displayed on a display screen of a wireless device, according to an embodiment of the present invention.

FIG. 3 is a general flow diagram illustrating a method for communicating incident scene information in an ad hoc network, from the perspective of a first wireless device, according to an embodiment of the present invention.

FIG. 4 is a general flow diagram illustrating a method for communicating incident scene information in an ad hoc network, from the perspective of a first wireless device, according to an embodiment of the present invention where the first wireless device provides “turnkey hotspot” or “hotspot in a box” services.

FIG. 5 is a general flow diagram illustrating a method for communicating incident scene information in an ad hoc network, where a first node in the network transmits an ISA to a second node in the network, according to an embodiment of the present invention.

FIG. 6 is a general flow diagram illustrating a method for communicating incident scene information in an ad hoc network, where a first node is authenticated via a second node, according to an embodiment of the present invention.

FIG. 7 is a general flow diagram illustrating a method for communicating incident scene information in an ad hoc network, according to an embodiment of the present invention where a first node in the network provides “turnkey hotspot” or “hotspot in a box” services.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to communicating incident scene information in an ad hoc network. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of communicating incident scene information in an ad hoc network described herein. The non-processor circuits may include, but are not limited to, a radio receiver, a radio transmitter, signal drivers, clock circuits, power source circuits, and user input devices. As such, these functions may be interpreted as steps of a method for communicating incident scene information in an ad hoc network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the present invention employ an ad hoc wireless network to provide information about an incident scene that is updatable in real-time. An Incident Scene Services Database (ISSD) is used to present summaries of data concerning an incident scene, enabling newly-arriving members of a response team to receive updated, readily intelligible information that can help them better assess present incident scene circumstances. Incident scenes according to the present invention can include various situations such as crime scenes, fire scenes, accident scenes, biological or chemical hazard scenes, and other types of emergency or otherwise critical scenes. Thus, when employing the present invention, response team members that arrive first at an incident scene do not need to spend valuable time repeatedly updating new team members upon their arrival to the scene. Rather, all team members can rely on the ISSD to provide a comprehensive and timely source of incident scene information, thus enabling safe, coordinated and effective responses.

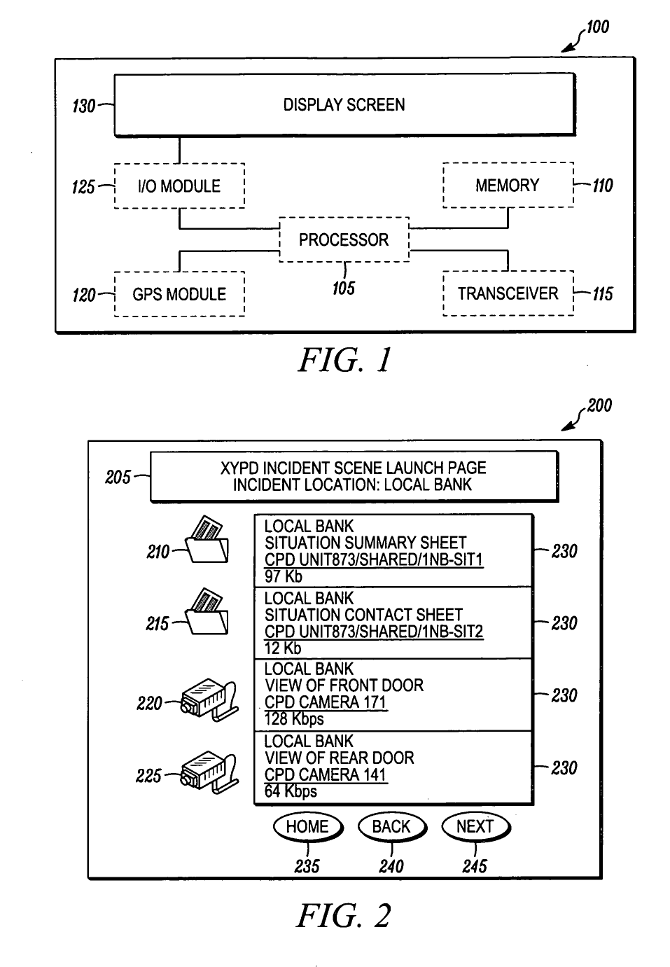

Referring to FIG. 1, a block diagram illustrates the functional components of a wireless device 100 that is a node of an ad hoc wireless network and that is adapted to perform functions of the present invention, according to an embodiment of the present invention. A processor 105 is operatively connected to various functional modules such as a memory 110, a transceiver 115, a Global Positioning System (GPS) module 120, and an Input/Output (I/O) module 125. The I/O module 125 is operatively connected to a display screen 130 and to other optional elements (not shown) such as a keypad, a microphone, a speaker, a camera, and the like. Those skilled in the art will appreciate that the wireless device 100 can be embodied in various types of hardware such as multifunction radios, mobile telephones, personal computers, or personal digital assistants (PDAs).

Those skilled in the art will further appreciate that the memory 110 can comprise various types of memory such as a random access memory (e.g., static random access memory (SRAM)), read only memory (e.g., programmable read only memory (PROM), or electrically erasable programmable read only memory (EPROM)), or hybrid memory (e.g., FLASH) as is well known in the art. The processor 105 then accesses a computer useable medium in the memory 110, which medium includes computer readable program code components configured to cause the wireless device 100 to execute the functions of the present invention.

It will be appreciated by those of ordinary skill in the art that the memory 110 can be integrated within the wireless device 100 or, alternatively, can be at least partially contained within an external memory such as a memory storage device. The memory storage device, for example, can be a subscriber identification module (SIM) card.

Referring to FIG. 2, a diagram illustrates elements of an incident scene launch page 200, according to an embodiment of the present invention. The launch page 200 is displayed on the display screen 130 of the wireless device 100 and is designed to provide a user, such as an incident scene response team member, of the wireless device 100 with an intuitive menu that can be used to readily assess information about a particular incident scene.

For example, the launch page 200 can include a header 205 that identifies a particular incident scene. For illustration purposes, the header 205 shown in FIG. 2 identifies an incident location as “Local Bank”, where hypothetically a robbery in progress may have been reported, and the launch page 200 may be displayed by a police officer that arrives at the scene and is using a handheld two-way radio comprising the wireless device 100. The header 205 is useful as accurate identification of an incident scene can be critical, particularly in dense urban areas where multiple incident scenes may transpire simultaneously and within close geographic proximity. If an emergency response team member arrives at one incident scene, but believes that he or she has arrived at another incident scene, immediate identification and correction of the error is important to help the team member function effectively and safely.

The launch page 200 can further include menu items such as a situation summary sheet icon 210, a situation contact sheet icon 215, a first camera view icon 220, and a second camera view icon 225. A textual description 230 is associated, respectively, with each menu item. A user can access described material by “clicking” or otherwise selecting a menu item. For example, after clicking or otherwise selecting the situation summary sheet icon 210, the display screen 130 can display a text document that provides a summary of known or estimated information that summarizes the circumstances of an incident scene. The summary can include for example the names and descriptions (and in one embodiment photographs) of victims, suspects, and other response team members that are already at the scene, as well as tactical response information.

Further, by clicking the situation contact sheet icon 215, the display screen 130 can display a text document that provides contact details of appropriate individuals in a response team command structure. Also, after clicking the first or second camera view icons 220, 225, the display screen 130 can display a live video or still-image feed of a particular aspect of an incident scene, such as a front or rear door of a building. The launch page 200 can also include navigation buttons such as a home button 235, back button 240 and next button 245, which enable a user to easily navigate to and from the launch page 200. For example the home button 235 can be used to navigate to a general menu that includes a link to an incident scene resource manager program, enabling the creation of links to internal or external resources such as a camera.

In light of the present disclosure, those skilled in the art will appreciate that an ISSD according to the present invention can include any type of database that includes information or links to information concerning an incident scene. Thus according to an embodiment of the present invention an ISSD can comprise a general database structure that is useful for providing information about an incident scene. Such information can include, for example, scene description summary data, contact data, real-time camera data, real-time microphone data, image data, and response team command structure data.

According to an embodiment of the present invention, the wireless device 100 can participate in an ad hoc incident scene communication network including other wireless devices, where the wireless device 100 and the other devices in the network each maintain a copy of an ISSD. When the wireless device 100 makes available a new service or modifies an existing service that is relevant for a particular ISSD, the wireless device 100 distributes throughout the network an Incident Service Advertisement (ISA) intended as an update of the ISSD. New services can include for example a new document relevant to an incident scene, or a new camera view of an incident scene. Modifications to an existing document can include for example the addition of new contact information to an existing situation contact sheet. When a new member arrives on the incident scene, that new member's information (i.e. name, description, photograph, communication method, and the like) can also be distributed to the other team members in this fashion.

An ISA can include a link, such as a hypertext markup language (HTML) link or another type of compressed Uniform Resource Locator (URL) link, to all services offered by the wireless device 100 that originates the ISA. According to other embodiments of the present invention, an ISA can itself include data concerning an incident scene. Distribution of an ISA can occur using various techniques known in the art, including, for example, flooding techniques such as Open Shortest Path First (OSPF) Link State Advertisement (LSA) flooding techniques.

A current ISA, one for each wireless device in an ad hoc network that provides a service for a particular ISSD, can be stored in the memory 110 of the wireless device 100. In one embodiment, an ISA can be stored with a time-out value that indicates a time in the future when the ISA will be automatically deleted from the ISSD. The wireless device 100 that provides a particular service can thus flood a copy of its current ISA to other wireless devices in the network at an interval that is a fraction of the ISA's time out value. Thus for example an ISA may be flooded three times before expiration of its time out value. Other wireless devices in the network that receive a copy of an existing ISA will then generally update the time out value of the ISA. Further, another wireless device in the ad hoc network that receives an ISA from the wireless device 100 can forward the ISA to still other wireless devices in the network. That enables incident scene information to be routed quickly and effectively through the ad hoc network.

According to an embodiment of the present invention, a local copy of an ISSD can be stored in the memory 110 of the wireless device 100 as a locally cached web page. Such an ISSD thus can be retrieved by a web browser of the wireless device 100 using an appropriate URL. According to a further embodiment of the present invention, an ISSD can be stored as a database in the memory 110 of the wireless device 100 and the wireless device 100 can act as a local web server. The wireless device 100 thus can push, in real time, updates of the ISSD to requesting web browsers in other wireless devices of an ad hoc network. As known to those skilled in the art, such local web services are sometimes referred to as “turnkey hotspot” or “hotspot in a box” services. For example, a notebook computer operating within range of an ad hoc network, which network includes the wireless device 100 acting as a web server, can obtain access to an ISSD managed by the wireless device 100 by activating in the notebook computer an Institute of Electrical and Electronics Engineers (IEEE) 802.11b network card. If the notebook computer then transmits to the wireless device 100 a hypertext transfer protocol (HTTP) request, the wireless device 100 will reply with data that, following an authorization procedure, enable the notebook computer to build a web page that can display incident scene information from the ISSD.

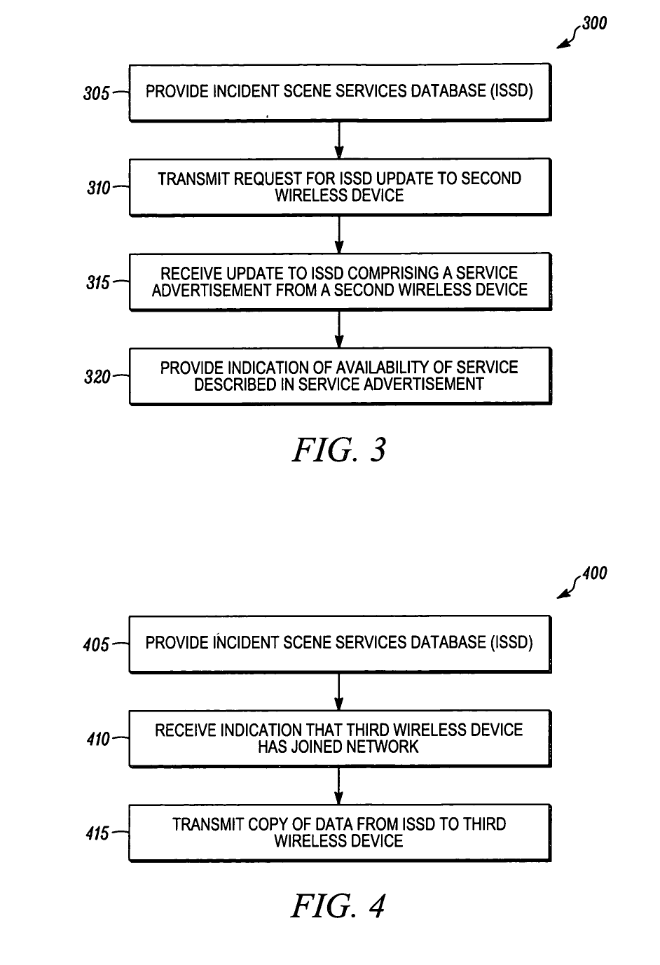

Referring to FIG. 3, a general flow diagram illustrates a method 300 for communicating incident scene information in an ad hoc network, from the perspective of the wireless device 100, according to an embodiment of the present invention. At step 305 an Incident Scene Services Database (ISSD) is provided in the wireless device 100. As described above, the ISSD can be stored in a memory 110 of the wireless device 100 and can include data and links to data, such as a link to a live camera feed associated within an incident scene.

At step 310, the wireless device 100 transmits to a second wireless device in the network a request for an update of the ISSD. For example, the wireless device 100 may arrive at an incident scene and authenticate itself with an existing ad hoc incident scene communication network. The wireless device 100 then identifies the second wireless device in the network as a node that can most effectively update the ISSD of the first device 100 with information about the present incident scene. Therefore the wireless device 100 transmits a request for an update of the ISSD to the second wireless device.

At step 315 an update of the ISSD is received at the wireless device 100 in response to the request transmitted at step 310. The update comprises an Incident Service Advertisement (ISA) from the second wireless device. For example the service advertisement can include a link to a real time camera feed that recently was set up and broadcast by the second wireless device.

At step 320 an indication is provided at the wireless device 100 of availability of a service described in the service advertisement received from the second wireless device. According to one embodiment of the present invention, the indication is a menu item displayed on the display screen 130 and comprising a link to a service described in the service advertisement. Thus a user of the wireless device 100 can click on or otherwise select the link associated with the menu item and obtain immediate access to the service described in the service advertisement. For example, as illustrated in FIG. 2, the launch page 200 includes menu items such as the situation summary sheet icon 210, the situation contact sheet icon 215, the first camera view icon 220, and the second camera view icon 225.

Referring to FIG. 4, a general flow diagram illustrates a method 400 for communicating incident scene information in an ad hoc network, from the perspective of the wireless device 100, according to an embodiment of the present invention where the wireless device 100 provides “turnkey hotspot” or “hotspot in a box” services. At step 405 an Incident Scene Services Database (ISSD) is provided in the wireless device 100. As described above, the ISSD can be stored in a memory 110 of the wireless device 100 and can include data and links to data, such as a link to a live camera feed associated with an incident scene.

At step 410 of the method 400, the wireless device 100 receives an indication that a third wireless device has joined the network. According to one example, the third wireless device may not yet have any information concerning the ISSD. The indication that the third wireless device has joined the network may be a simple request for a Uniform Resource Locator (URL) unrelated to the ISSD. The wireless device 100 then can act as a “turnkey hotspot” server or a “hotspot in a box” server, as described above, and build a web page in HTML format from data in the ISSD. At step 415, the wireless device 100 then transmits the web page to the third wireless device in response to the URL request that was sent by the third wireless device.

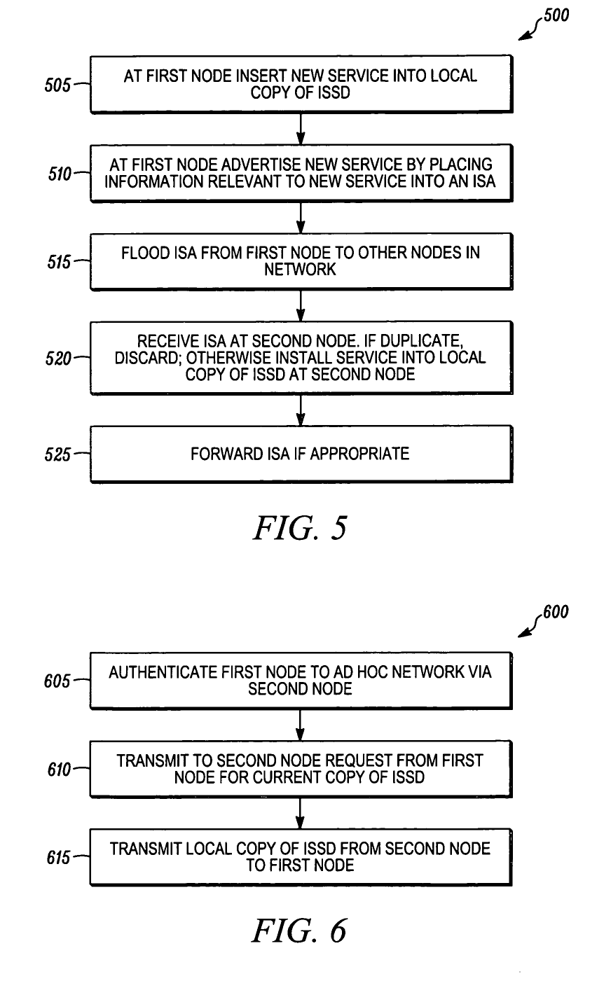

Specific features of the present invention are further described below with reference to FIGS. 5, 6 and 7, and concerning interactions between first and second nodes in an ad hoc network. The first and second nodes in the network can include for example components of the wireless device 100 described above.

Referring to FIG. 5, a general flow diagram illustrates a method 500 for communicating incident scene information in an ad hoc network, where a first node in the network transmits an ISA to a second node in the network, according to an embodiment of the present invention. At step 505 the first node inserts a new service, such as a live video link from a camera, into a local copy of an ISSD. At step 510, the first node advertises the new service to other network nodes by placing information relevant to the new service in an ISA. At step 515, the first node floods the ISA to other nodes in the network. At step 520, the second node in the network receives the ISA. If the second node already has a copy of the ISA, the received ISA is deleted; otherwise the new service advertised by the ISA is installed in a local copy of the ISSD at the second node. Finally, at step 525, if requested by a third node, or if otherwise appropriate, the second node forwards the ISA to a third node in the network.

Referring to FIG. 6, a general flow diagram illustrates a method 600 for communicating incident scene information in an ad hoc network, where a first node is authenticated via a second node, according to an embodiment of the present invention. At step 605, the first node authenticates itself with the ad hoc network via the second node. For example, the first node may be associated with a police officer who has just arrived at a crime scene, and the second node is associated with another police officer who has been present at the crime scene for a period of time. At step 610, the first node transmits a request to the second node for a current copy of a particular ISSD. For example, the ISSD may describe details of the crime scene, list the names and photographs of police officers who are present at the scene, and provide several live video feeds of different locations at the scene. At step 615, the second node then transmits to the first node a local copy of the ISSD that is stored at the second node.

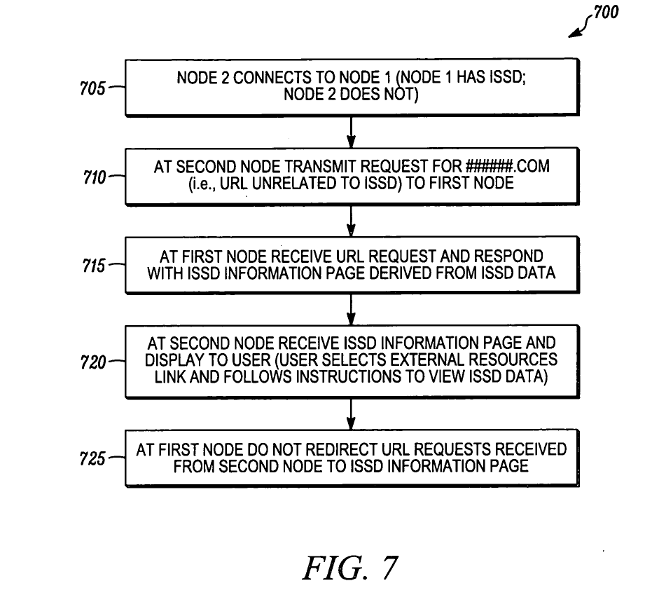

Referring to FIG. 7, a general flow diagram illustrates a method 700 for communicating incident scene information in an ad hoc network, according to an embodiment of the present invention where a first node in the network provides “turnkey hotspot” or “hotspot in a box” services. At step 705 a second node that does not have a copy of an ISSD connects to the first node that does have a copy of an ISSD. At step 710 the second node transmits to the first node a URL request for a web site such as ######.com, or some other URL that is unrelated to the ISSD. At step 715, the first node receives the URL request and responds by transmitting to the second node an ISSD information page derived from ISSD data. At step 720, the second node receives the ISSD information page and displays it to a user. The user selects an external resources link and then follows instructions that are provided by the link for viewing ISSD data. Thus the second node is able to act as a terminal that receives ISSD data from the first node that acts as a “turnkey hotspot” server. Finally, at step 725, the first node ensures that it does not redirect subsequent URL requests, which are received from the second node, to the ISSD information page.

Embodiments of the present invention therefore enable ad hoc wireless networks to provide information about an incident scene that is updatable in real-time. An Incident Scene Services Database (ISSD) is used to present summaries of data concerning an incident scene, enabling newly-arriving members of a response team to receive updated, readily intelligible information that can help them better assess present incident scene circumstances, without requiring time-consuming interactions with other response team members. Timely updates to the ISSD are made through Incident Service Advertisements (ISAs) sent from various wireless devices 100 in the ad hoc network. All team members can thus rely on the ISSD to provide a comprehensive and timely source of incident scene information, enabling safe, coordinated and effective incident scene responses.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for communicating incident scene information between wireless devices in an ad hoc wireless communication network, the method comprising:
providing an Incident Scene Services Database (ISSD) in a first wireless device;
receiving at the first wireless device an update element of the ISSD comprising a service advertisement from a second wireless device; and
providing an indication at the first wireless device of availability of a service described in the service advertisement received from the second wireless device.

2. The method of claim 1, wherein the indication at the first wireless device of availability of a service described in the service advertisement is a menu item, comprising a link to a service described in the service advertisement, provided on a display screen of the first wireless device.

3. The method of claim 1, wherein the ISSD comprises a cached web page displayed by a web browser on a display screen of the first wireless device.

4. The method of claim 1, wherein data from the ISSD is included on a web page displayed by a web browser on a display screen of the first wireless device.

5. The method of claim 1, wherein the service advertisement comprises a time out value that causes the service advertisement to be deleted from the ISSD after a predetermined time period.

6. The method of claim 1, wherein the first wireless device performs as a turnkey hotspot web server that transmits data from the ISSD to a third wireless device.

7. The method of claim 1, wherein the service advertisement comprises a Uniform Resource Locator (URL) that links to a listing of services provided by the second wireless device.

8. The method of claim 1, wherein the second wireless device is an originator of the service advertisement and the update element of the ISSD is flooded to a plurality of wireless devices including the first wireless device.

9. The method of claim 1, wherein the ISSD comprises a plurality of service advertisements received from a plurality of wireless devices in the ad hoc wireless communication network.

10. The method of claim 1, further comprising:
receiving at the first wireless device an indication that a third wireless device has joined the ad hoc wireless communication network; and
transmitting from the first wireless device to the third wireless device data from the ISSD including data from the service advertisement received from the second wireless device.

11. The method of claim 1, wherein the ISSD comprises incident scene information selected from a group comprising: scene description summary data, contact data, real-time camera data, real-time microphone data, image data, and response team command structure data.

12. A system for communicating incident scene information between wireless devices in an ad hoc wireless communication network, comprising:
computer readable program code components configured to cause a first wireless device to provide an Incident Scene Services Database (ISSD);
computer readable program code components configured to cause the first wireless device to process an update element of the ISSD comprising a service advertisement received from a second wireless device; and
computer readable program code components configured to cause the first wireless device to provide an indication at the first wireless device of availability of a service described in the service advertisement received from the second wireless device.

13. The system of claim 12, wherein the indication at the first wireless device of availability of a service described in the service advertisement is a menu item, comprising a link to a service described in the service advertisement, provided on a display screen of the first wireless device.

14. The system of claim 12, wherein the ISSD comprises a cached web page displayed by a web browser on a display screen of the first wireless device.

15. The system of claim 12, wherein data from the ISSD is included on a web page displayed by a web browser on a display screen of the first wireless device.

16. The system of claim 12, wherein the service advertisement comprises a time out value that causes the service advertisement to be deleted from the ISSD after a predetermined time period.

17. The system of claim 12, wherein the first wireless device performs as a turnkey hotspot web server that transmits data from the ISSD to a third wireless device.

18. The system of claim 12, wherein the service advertisement comprises a Uniform Resource Locator (URL) that links to a listing of services provided by the second wireless device.

19. The system of claim 12, further comprising:
computer readable program code components configured to cause the first wireless device to process an indication that a third wireless device has joined the ad hoc wireless communication network; and
computer readable program code components configured to cause the first wireless device to transmit to the third wireless device data from the ISSD including data from the service advertisement received from the second wireless device.

20. A system for communicating incident scene information between wireless devices in an ad hoc wireless communication network, the system comprising:
means for providing an Incident Scene Services Database (ISSD) in a first wireless device;
means for receiving at the first wireless device an update element of the ISSD comprising a service advertisement from a second wireless device; and
means for providing an indication at the first wireless device of availability of a service described in the service advertisement received from the second wireless device.
